(19) United States
(12) Patent Application Publication
(10) Pub. No.: US 2007/0003285 A1
(43) Pub. Date: Jan. 4, 2007

(54) Optical signal source wavelength stabilization system and method

(76) Inventors: A. Douglas Meyer, Woodland Hills, CA (US); David B. Hall, La Crescenta, CA (US)

Correspondence Address: John H. Lynn, Suite C 103, 2915 Redhill Ave., Costa Mesa, CA, 92626, US

(21) Appl. No.: 11/322,081

(22) Filed: Dec. 29, 2005

Related U.S. Application Data
(60) Provisional application No. 60/695,761, filed on Jun. 30, 2005.

(51) Int. Cl. H04J 14/02

(52) U.S. Cl. 398/85

(57) ABSTRACT

Apparatus for stabilizing wavelength of an optical signal output from an optical signal source comprises an optical fiber arranged to receive an optical signal from the optical signal source and an optical tap arranged to couple a control signal out of the optical fiber. An optical signal splitter is arranged to divide the control portion into a first portion having a wavelength-dependent intensity I₁ and a second portion having a wavelength-dependent intensity I₂. A control circuit is arranged to compute a ratio R=I₁/I₂ and to send an error signal to the optical signal source if wavelength drift in the optical signal source causes the ratio R to deviate from a predetermined set point.

### CROSS REFERENCE TO RELATED APPLICATION

Applicants claim priority based on Provisional Application Ser. No. 60/695,761, filed Jun. 30, 2005.

### BACKGROUND OF THE INVENTION

This invention relates generally to fiber optic sensors and particularly to fiber optic rotation sensors, which are also known as fiber optic gyroscopes (FOG). Still more particularly, this invention relates providing an optical signal source for FOG applications that has improved wavelength stability over an operating temperature range.

Broadband optical sources are typically used in sensing applications and are the primary signal sources used in FOG applications. The gyro scale factor (SF_{gyro}) stability is highly dependent on the wavelength stability of the signal source as can be seen from the following equation:

$${SF}_{gyro} = \frac{g π AN}{{λ}_{c} c} \qquad ( 1 )$$

where A is the enclosed area of the optical path, n is the number of turns in the fiber optic coil, c is the speed of light in vacuum and λ_{c} is the wavelength centroid. It can be seen from Equation (1) that if λ_{c} changes, the scale factor of the gyro is affected. In order to improve the scale factor performance, the wavelength must either be stabilized over temperature and time, or appropriate information must be gathered so as to provide a means for modeling the wavelength drift out of the gyro performance.

### SUMMARY OF THE INVENTION

The present invention is directed to stabilizing the wavelength of a broadband optical signal source that is suitable for use in a FOG system. The present invention is applicable to both super-fluorescent fiber (SFS) and to super-luminescent diode (SLD) based optical signal sources. In each case the source spectrum is broad, typically 20 nm to 50 nm at the 3 dB point with a central wavelength that drifts with temperature.

An apparatus according to the present invention for providing wavelength stability in an optical signal output from an optical signal source comprises an optical fiber arranged to receive an optical signal from the optical signal source and an optical tap arranged to couple a control portion of the optical signal out of the optical fiber. An optical signal splitter is arranged to divide the control portion into a first portion having a wavelength-dependent intensity I₁ and a second portion having a wavelength-dependent intensity I₂. A control circuit is arranged to compute a ratio R=I₁/I₂ and to send an error signal to the optical signal source if wavelength drift in the optical signal source causes the ratio R to deviate from a predetermined set point.

The apparatus may further comprise a first photodetector connected to the control circuit and arranged to produce an electrical signal that indicates the intensity I₁ and a second photodetector connected to the control circuit and arranged to produce an electrical signal that indicates the intensity I₂.

The optical signal splitter may comprise an optical slope filter formed to output a transmitted portion having the wavelength-dependent intensity I₁ and the reflected portion having the wavelength-dependent intensity I₂.

The optical signal splitter may alternatively comprise a wavelength independent optical coupler arranged to divide the control signal into a first portion and a second portion and a first optical edge or bandpass filter arranged such that the first portion of the control signal is incident thereon, the first optical edge or bandpass filter being formed to transmit an optical signal I₁ in a first wavelength band. A second optical edge or bandpass filter may be arranged such that the second portion of the control signal is incident thereon, the second optical edge filter being formed to transmit an optical signal I₂ in a second wavelength band.

The optical signal splitter may alternatively comprise a first optical fiber arranged such that the control signal is coupled into it, an optical coupler arranged to divide the control signal into a first control portion that remains guided by the first optical fiber and a second control portion that is coupled out of the first optical fiber. A second optical coupler may be connected to the first optical fiber, a second optical fiber arranged to receive the first control portion from the second optical coupler, a first fiber Bragg grating formed in the second optical fiber and arranged to form the optical signal I₁ in a first wavelength band, a third optical fiber arranged to receive the second control portion from the first optical coupler and a second fiber Bragg grating formed in the third optical fiber and arranged to form the optical signal I₂ in a second wavelength band.

The optical signal splitter may comprise a first optical fiber arranged such that the control signal is coupled into it, an optical coupler arranged to divide the control signal into a first control portion that remains guided by the first optical fiber and a second control portion that is coupled out of the first optical fiber, a fiber Bragg grating formed in the first optical fiber, the fiber Bragg grating being formed to transmit a first optical frequency to form the optical signal I₁ in a first wavelength band and being further formed to reflect back to the optical coupler a second optical frequency to form the optical signal I₂ in a second wavelength band and a second optical fiber connected to the optical coupler and arranged to receive the optical signal I₂ therefrom.

### BRIEF DESCRIPTION OF THE DRAWINGS

FIG. 1 graphically illustrates wavelength shift as a function of temperature for a typical optical signal source used in FOG applications;

FIG. 2 schematically illustrates a first embodiment of a source stabilization system according to the present invention;

FIG. 3 schematically illustrates an embodiment of the invention that uses edge filters for optical signal source stabilization control;

FIG. 4A graphically illustrates the effects of optical signal source spectra edge filters;

FIG. 4B graphically illustrates the effects of shifted optical signal source spectra and edge filters;

FIG. 4C shows the spectrum of an optical signal source and shows blue and red edge filters;

FIG. 4D shows the spectrum of an optical signal source and shows blue and red edge filters after a temperature change has caused frequency shifts;

FIG. 5 schematically illustrates an embodiment of the invention that includes a pair of athermal fiber Bragg gratings;

FIG. 6 schematically illustrates an embodiment of the invention that uses a single fiber Bragg grating to provide optical signal source stabilization; and

FIG. 7 shows an embodiment of the invention similar to that shown in FIG. 6 that includes an optical circulator instead of an optical coupler.

### DETAILED DESCRIPTION OF THE INVENTION

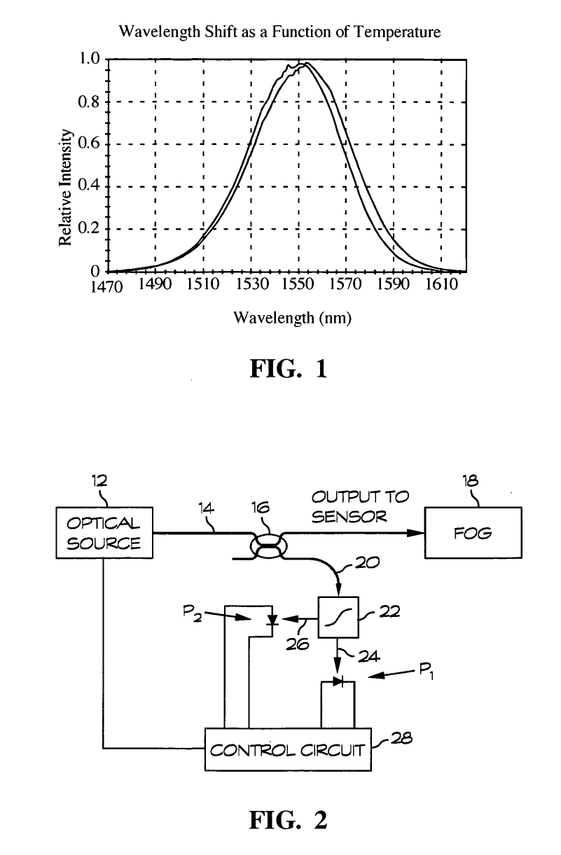

FIG. 1 shows spectral diagrams for a typical SLD at two different temperatures. FIG. 1 has a solid line that represents relative intensity as a function of wavelength at a temperature of 17° C. A dashed line represents the relative intensity as function of wavelength at a temperature of 24° C. It is readily seen from FIG. 1 that a shift of about 3 nm in the wavelength for maximum intensity occurs over the 7° C. temperature change.

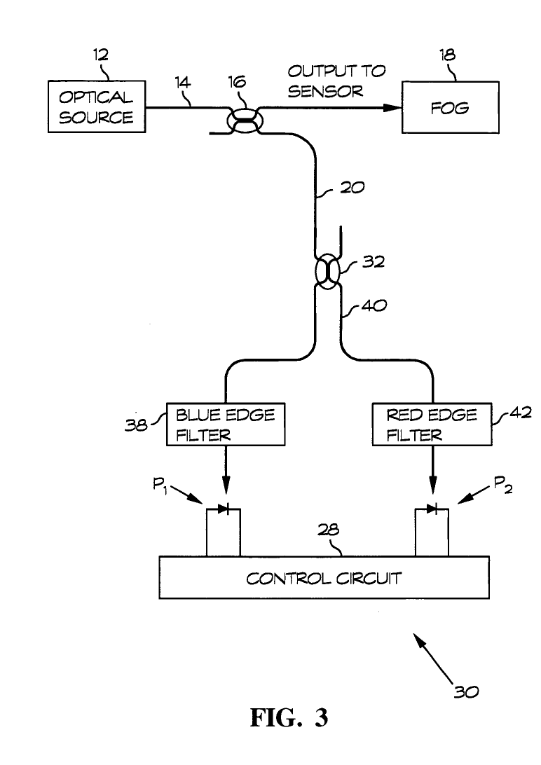

FIG. 2 shows an optical signal source stabilization system 10 according to the invention. An optical signal source 12 provides optical signals to a first optical fiber 14. The optical fiber 14 guides the optical signals from the optical signal source 12 to a fiber optic coupler 16. The coupler 16 outputs most of the source light to a FOG 18, which is typically used in rotation sensing applications. Suitable structures for the fiber optic coupler 16 and the FOG 18 are well known in the art and need not be described herein.

The fiber optic coupler 16 couples a portion of the source light into a second optical fiber 20. The term “tap coupler” is sometimes used to refer to the fiber optic coupler 16. Source light that is coupled out of the optical fiber 14 is sometimes called “tapped light.” The optical fiber 20 guides the tapped light to an optical slope filter 22 that is arranged to transmit a first portion of the tapped light (represented by an arrow 24) and reflect a second portion (represented by an arrow 26). The optical slope filter 22 is arranged such that the ratio of the transmitted intensity to the reflected intensity is a function of optical wavelength of the tapped light. The optical slope filter is arranged so that a predetermined ratio value is set to select the desired wavelength for input to the FOG 18.

The transmitted portion 24 of the tapped light is incident upon a first photodetector P₁, and the reflected portion 26 is incident upon a second photodetector P₂. The photodetectors P₁ and P₂ produce electrical signals corresponding to the intensities of the transmitted tap light 24 and the reflected tap light 26, respectively. The photodetectors P₁ and P₂ are connected to a control circuit 28 that is arranged to produce an error signal that indicates deviation of the source wavelength from the selected wavelength. The error signal is fed back to the optical signal source 12 to adjust the wavelength of the optical signal input to the optical fiber 14 and the FOG 18.

The ratio of the transmitted tap light intensity to the reflected tap light intensity is set to a fixed set point that indicates that the source light has the selected wavelength. Any change in the source wavelength changes the ratio calculated by the control circuit 28. The difference between the actual ratio as determined by the control circuit 28 and the set point is used to produce the error signal that is fed back to the optical signal source to correct for the shift in wavelength away from the selected value. It should be noted that because the ratio of the signals produced by the photodetectors P₁ and P₂ is used to determine the error signal, fluctuations in the intensity of the source signal are not detected by the optical signal source stabilization system 10. Such fluctuations appear in both the transmitted portion 24 and the reflected portion 26 so that the fluctuations divide out of the ratio calculation.

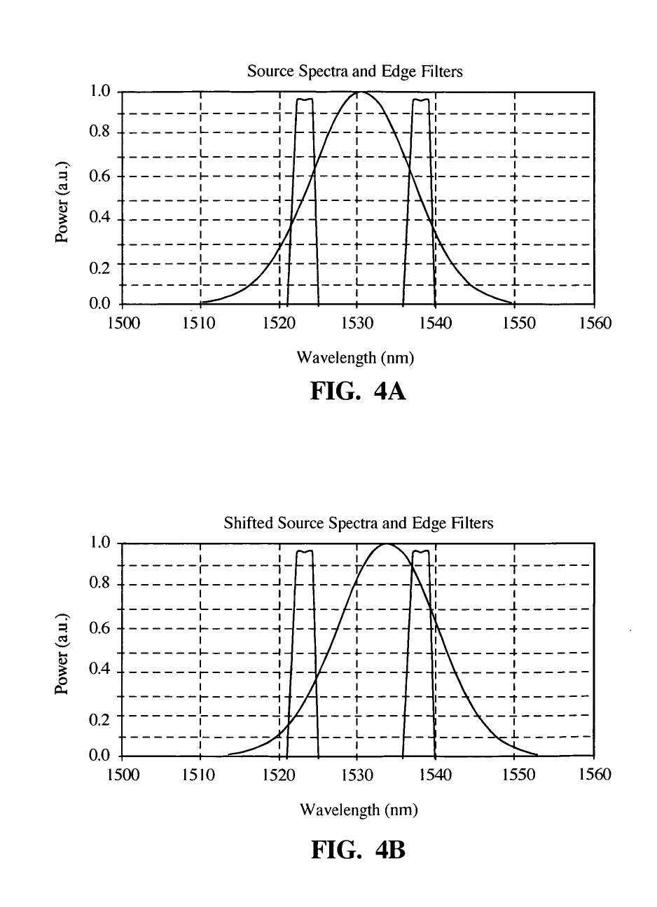

FIG. 3 illustrates an optical signal source stabilization system 30 according to the invention. FIG. 3 is similar to FIG. 2 with the only difference being the substitution of an optical coupler 32 and a pair of bandpass filters 38 and 42 for the optical slope filter 22. The tapped signal is input from the optical fiber 20 into the optical coupler 32, which divides the tapped signal into two essentially equal signals. The coupling characteristics of the optical coupler 32 preferably are independent of the wavelength of the tapped signal. Light that remains in the optical fiber 20 is input to a blue-edge filter 38. The optical coupler couples half of the tapped signal into an optical fiber 40, which guides the coupled tapped light to a red-edge filter 42. Signals output from the blue-edge filter 38 and the red-edge filter 42 are incident upon corresponding photodetectors P₁ and P₂, respectively.

The photodetectors P₁ and P₂ provide electrical signals to the control circuit 28 to indicate the intensities of the optical signals output from the bandpass filters 38 and 42. The ratio of these intensities is set to a fixed value for a selected wavelength to be output from the optical signal source 12. Deviations in the source wavelength from the selected wavelength change the ratio of the intensities. The change in intensity ratio is used to form an error signal that is used to adjust the wavelength of the optical signal source back to the selected value.

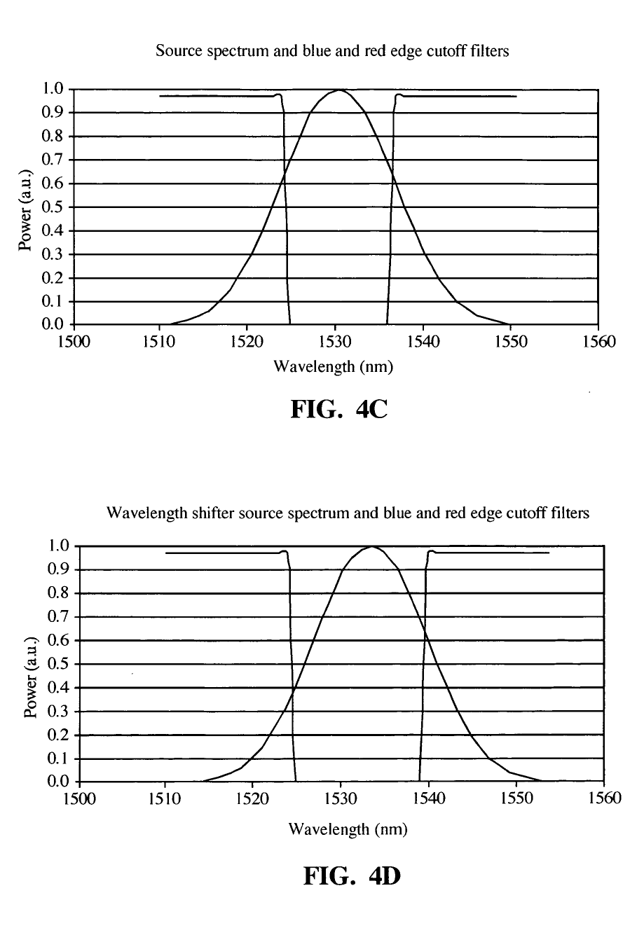

FIG. 4A graphically illustrates the intensity of the source signal as a function of wavelength at a selected temperature T. FIG. 4A also shows the bandpass characteristics of the bandpass filters 38 and 42. The bandpass filters 38 and 42 are arranged so that the intensities passed through them are equal. FIG. 4B shows the source signal intensity versus wavelength at a temperature T+ΔT. The source signal is shifted to the right, which causes the signals passed by the bandpass filters 38 and 42 to be different.

As the source wavelength spectrum has a finite bandwidth, usually 30 to 60 nm, terms have been given to describe the location on the spectral shape with respect to the wavelength centroid. Spectral portions to the left of the centroid are termed blue edge components and spectral portions to the right of the centroid are termed red edge components.

Both passband and cutoff filters can be used as the blue and red edge filters to affect monitoring of the wavelength shift in a broadband optical source. Illustrated in FIG. 4A are two passband filters, one is applied to the blue edge (left side) of the spectrum, the other to the red edge (right side) of the spectrum, illustrated in FIG. 4B the same filters on a wavelength shifted spectrum.

Alternatively, cutoff filters can be used. The transfer function of this filter must have a sharp transition characteristic between the transmitted and non-transmitted wavelengths. Illustrated in FIGS. 4C and 4D are cutoff filters applied to a non-shifted and a shifted source spectrum, respectively. It is clearly shown functionally both the passband and cutoff filter approach will result in wavelength stabilization.

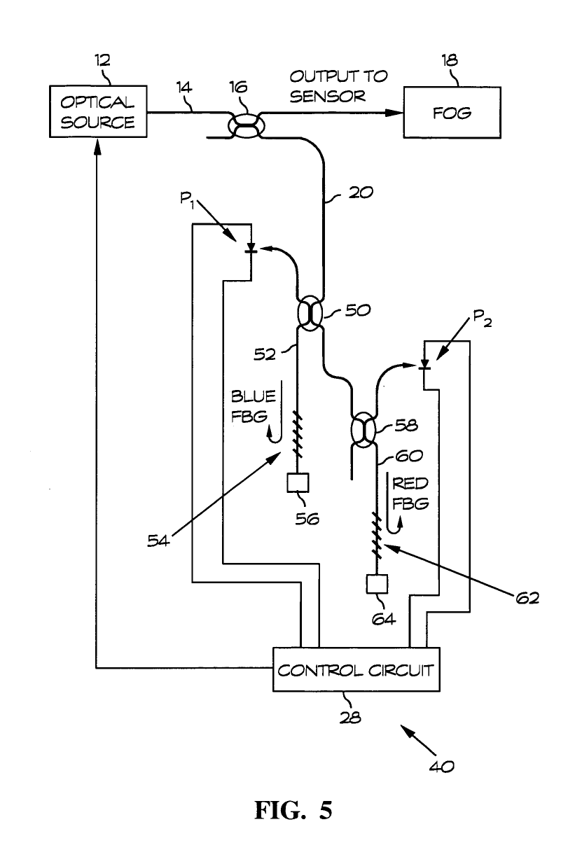

FIG. 5 illustrates an optical signal source stabilization system 40 that is similar to the embodiments of the invention shown in FIGS. 2 and 3. The optical fiber 20 guides the tapped signal to an optical coupler 50 that is arranged to divide the tapped signal equally between the optical fiber 20 and an optical fiber 52. The optical fiber 52 guides the portion of the tapped signal therein to a fiber Bragg grating (FBG) 54. The FBG 54 reflects a first selected wavelength band of the source spectrum back toward the optical coupler 50. The portion of the optical signal in the optical fiber 52 that is not reflected is absorbed by an optical terminator 56 that is arranged to receive light from the optical fiber 52. Part of the light reflected by the FBG 54 passes through the optical coupler 50 and is incident upon the photodetector P₁.

Light that passes through the optical coupler 50 in the optical fiber 20 propagates in the optical fiber 20 to an optical coupler 58. The optical fiber 58 couples a portion of the tapped signal into an optical fiber 60 that is arranged to guide optical signals therein to an FBG 62. The FBG 62 reflects a second selected portion of the source spectrum back toward the optical coupler 58. Light that is not reflected by the FBG 62 is absorbed by an optical terminator 64 that is arranged to receive optical signals from the optical fiber 60. A portion of the tapped signal that is reflected by the FBG 62 passes through the optical coupler 58 is guided by the optical fiber 60 the photodetector P₂₊.

The photodetectors P₁ and P₂ produce electrical signals corresponding to the intensities of the selected wavelengths. These electrical signals may be processed as described above by the control circuit 28 to produce an error signal that is used to adjust the source wavelength when it is necessary.

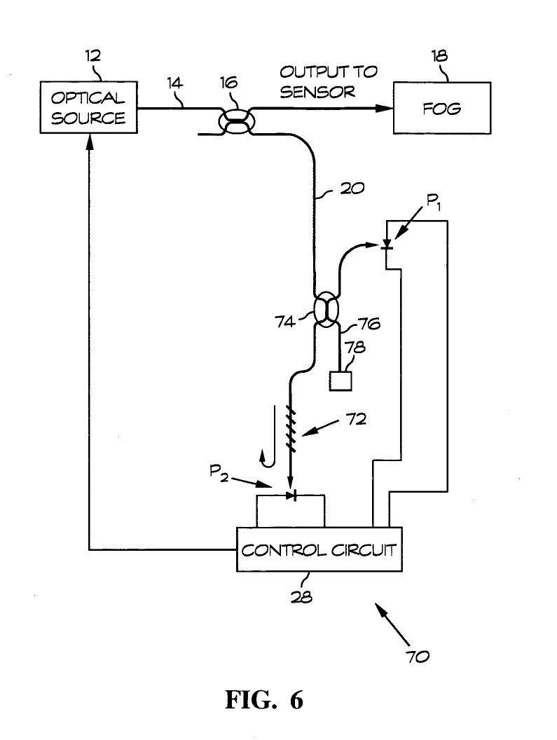

FIG. 6 shows an optical signal source stabilization system 70 that uses only one athermal FBG 72. The optical fiber 20 guides the tapped signal to an optical coupler 74, which outputs a transmitted portion that remains in the optical fiber 20 and a coupled portion that couples into an optical fiber 76. An optical terminator 78 absorbs the coupled portion. The transmitted portion propagates in the optical fiber 20 to the FBG 72, which reflects a portion of the tapped signal back to the optical coupler 74. The optical coupler 74 couples part of the reflected tapped signal into the optical fiber 76 which guides part of the reflected tapped signal to the photodetector P₁. The portion of the tapped signal that passes through the FBG unreflected is incident upon the photodetector P₂. Taking the ratio of electrical signals produced by the photodetectors P₁ and P₂ will again give information that can be used to produce an error signal that is fed back to the optical signal source 12 to correct for wavelength drift.

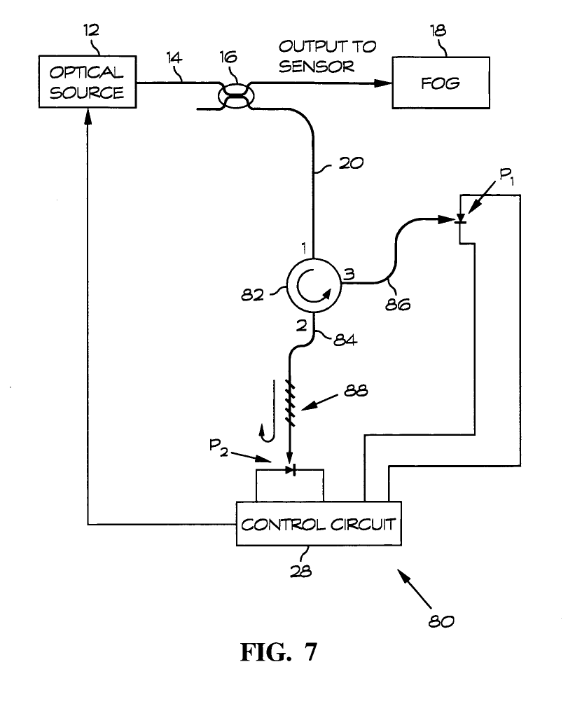

FIG. 7 is a schematic representation of a source wavelength stabilization system 80 using a single FBG 72 and optical circulator 82. The configuration shown in FIG. 7 is similar to the optical signal source stabilization system 70 shown in FIG. 6. The wavelength independent coupler 74 of FIG. 6 is replaced with the three-port optical circulator 82. The optical circulator 82 has ports 1-3. The optical fiber 20 is connected to port 1 to provide optical signals from the optical signal source 12 to the optical circulator. An optical fiber 84 is connected to port 2, and an optical fiber 86 is connected to port 3. The optical circulator 82 may be configured as a three-port device that is capable of rotating the inputs and outputs of the device in a cyclic manner. That is, a signal input on port 1 will exit the optical circulator 82 on port 2, and a signal input on port 2 will exit on port 3. Signals are prevented from passing from the first port to the third port and the second port to the first. The input output relation can be expressed as 1→2→3→1. The optical circulator approach has an advantage over the use of the 3 dB coupler in that he optical loss penalty is lower when using the circulator 82. A typical optical circulator has about 0.75 dB of loss port-to-port, while the 3 dB coupler has 3 dB of loss input to output. The configurations shown in FIGS. 6 and 7 the optical loss incurred is 6 dB and 1.5 dB, respectively, for the power observed at photodetector P₁.

The signal input to port 1 of the optical circulator 82 is therefore output therefrom at port 2 into the optical fiber 84, which is arranged to guide the signal to an FBG 88. A first part of the signal input to the FBG is reflected so that it propagates in the optical fiber 84 to port 2 of the optical circulator 82. This first part of the signal is then output from the optical circulator 82 at port 3 into the optical fiber 86. The reflected part of the signal is detected by the photodetector P₁.

A second part of the signal incident upon the FBG 88 is transmitted in the optical fiber 84 to the photodetector P₂. The electrical signals produced by the photodetectors P₁ and P₂ are processed as described above with reference to FIG. 6 to produce an error signal that is used to adjust the wavelength output from the optical signal source 12.

What is claimed is:

1. Apparatus for providing wavelength stability in an optical signal output from an optical signal source, comprising:
an optical fiber arranged to receive an optical signal from the optical signal source;
an optical tap arranged to couple a control signal out of the optical signal guided by the optical fiber;
an optical signal splitter arranged to divide the control signal into a first portion having a wavelength-dependent intensity I₁ and a second portion having a wavelength-dependent intensity I₂; and
a control circuit arranged to compute a ratio R=I₁/I₂ and to send an error signal to the optical signal source if wavelength drift in the optical signal source causes the ratio R to deviate from a predetermined set point.

2. The apparatus of claim 1, further comprising a first photodetector connected to the control circuit and arranged to produce an electrical signal that indicates the intensity I₁ and a second photodetector connected to the control circuit and arranged to produce an electrical signal that indicates the intensity I₂.

3. The apparatus of claim 2 wherein the optical signal splitter comprises an optical slope filter formed to output a transmitted portion having the wavelength-dependent intensity I₁ and the reflected portion having the wavelength-dependent intensity I_{R}.

4. The apparatus of claim 2 wherein the optical signal splitter comprises:
a wavelength independent optical coupler arranged to divide the control signal into a first portion and a second portion;
a first optical edge filter arranged such that the first portion of the control signal is incident thereon, the first optical edge filter being formed to transmit an optical signal I₁ in a first wavelength band; and
a second optical edge filter arranged such that the second portion of the control signal is incident thereon, the second optical edge filter being formed to transmit an optical signal I₂ in a second wavelength band.

5. The apparatus of claim 1 wherein the optical signal splitter comprises:
a wavelength independent optical coupler arranged to divide the control signal into a first portion and a second portion;
a first optical edge filter arranged such that the first portion of the control signal is incident thereon, the first optical edge filter being formed to transmit the optical signal I₁ in a first wavelength band; and
a second optical edge filter arranged such that the second portion of the control signal is incident thereon, the second optical edge filter being formed to transmit the optical signal I₂ in a second wavelength band.

6. The apparatus of claim 1 wherein the optical signal splitter comprises:
a first optical fiber arranged such that the control signal is coupled into it;
an optical coupler arranged to divide the control signal into a first control portion that remains guided by the first optical fiber and a second control portion that is coupled out of the first optical fiber;
a second optical coupler connected to the first optical fiber;
a second optical fiber arranged to receive the first control portion from the second optical coupler;
a first fiber Bragg grating formed in the second optical fiber and arranged to form the optical signal I₁ in a first wavelength band;
a third optical fiber arranged to receive the second control portion from the first optical coupler; and
a second fiber Bragg grating formed in the third optical fiber and arranged to form the optical signal I₂ in a second wavelength band.

7. The apparatus of claim 1 wherein the optical signal splitter comprises:
a first optical fiber arranged such that the control signal is coupled into it;
an optical coupler arranged to divide the control signal into a first control portion that remains guided by the first optical fiber and a second control portion that is coupled out of the first optical fiber;
a fiber Bragg grating formed in the first optical fiber, the fiber Bragg grating being formed to transmit a first optical frequency to form the optical signal I₁ in a first wavelength band and being further formed to reflect back to the optical coupler a second optical frequency to form the optical signal I₂ in a second wavelength band; and
a second optical fiber connected to the optical coupler and arranged to receive the optical signal I₂ therefrom.

8. The apparatus of claim 1 wherein the optical signal splitter comprises:
a first optical fiber arranged such that the control signal is coupled into it;
a wavelength independent optical circulator arranged to divide the control signal into a first control portion that remains guided by the first optical fiber and a second control portion that is coupled out of the first optical fiber;
a fiber Bragg grating formed in the first optical fiber, the fiber Bragg grating being formed to transmit a first optical frequency to form the optical signal I₁ in a first wavelength band and being further formed to reflect back to the optical circulator a second optical frequency to form the optical signal I₂ in a second wavelength band; and
a second optical fiber connected to the optical circulator and arranged to receive the optical signal I₂ therefrom.
